(19) United States
(12) Patent Application Publication
(10) Pub. No.: US 2026/0330685 A1
(43) Pub. Date: Oct. 22, 2026

(54) REAL-TIME CAMERA CALIBRATION AND OVERLAY FOR VEHICLE CAMERA MONITOR SYSTEM

(71) Applicant: Stoneridge Electronics AB, Solna (SE)

(72) Inventors: Yu He, Dearborn Heights, MI (US); Utkarsh Sharma, Farmington Hills, MI (US); Liang Ma, Rochester, MI (US)

(21) Appl. No.: 19/182,867

(22) Filed: Apr. 18, 2025

(51) Int. Cl. G06T 7/80; B60R 1/24; B60R 1/25

(52) U.S. Cl. CPC G06T 7/80; B60R 1/24; B60R 1/25; B60R 2300/105; B60R 2300/307; B60R 2300/802; B60Y 2200/148; G06T 2207/30252

(57) ABSTRACT

A method for calibrating a camera position on a vehicle includes receiving an image from a camera at a controller, the image including a portion of a vehicle to which the camera is mounted. The controller identifies a plurality of features on the portion of the vehicle in the image. The controller matches the identified plurality of features to a saved plurality of features. The controller determines a true extrinsic based upon step the matched plurality of features, wherein the true extrinsic relates a position and orientation of the camera in six degrees of freedom to the vehicle.

### TECHNICAL FIELD

This disclosure relates to real-time camera calibration and overlay for vehicle camera monitor system.

### BACKGROUND

Mirror replacement systems, and camera systems for supplementing mirror views, are utilized in commercial vehicles to enhance the ability of a vehicle operator to see a surrounding environment. Camera monitoring systems (CMS) utilize one or more cameras to provide an enhanced field of view to a vehicle operator. In some examples, the mirror replacement systems cover a larger field of view than a conventional mirror or include views that are not fully obtainable via a conventional mirror.

During operation of the vehicle, certain CMS features rely on and utilize multiple aspects of the images generated by the CMS cameras for object detection, operation of direct CMS functions (e.g. mirror replacement displays), provision of data to other vehicle systems, and the like. Some of these systems and functions utilize features within the image, such as a trailer corner or a static marker located at a known height and position relative to the cameras in order to determine a reference position within the image.

Existing systems either assume that the camera is at a predefined “stock” position relative to the ground plane, with the stock position being determined at assembly or assume that the position is at a calibration position determined via a calibration performed while the truck is stationary. Reliance on pre-existing calibrated reference positions can result in less accuracy when the camera position has changed since the default height was selected. The camera position and orientation may change due to multiple reasons such as foreign object impact or mechanical wear and tear. As a result, the camera would need to be re-calibrated. Otherwise, image processing features may suffer degraded performance due to incorrect camera extrinsic.

One existing system corrects for some changes to the camera position by calculating changes in a yaw angle and a pitch angle of the camera compared to an ideal position and orientation of the camera relative to the vehicle. Another existing system calculates height changes of the camera relative to the ideal position of the camera relative to the vehicle.

### SUMMARY

In some aspects, the techniques described herein relate to a method for calibrating a camera position on a vehicle including receiving an image from a camera at a controller, the image including a portion of a vehicle to which the camera is mounted. The controller identifies a plurality of features on the portion of the vehicle in the image. The controller matches the plurality of identified features to a saved plurality of features. The controller determines a true extrinsic based upon the matched features, wherein the true extrinsic relates a position and orientation of the camera in six degrees of freedom to the vehicle.

In some aspects, the techniques described herein relate to a method, wherein the camera is a rear facing arm mounted camera.

In some aspects, the techniques described herein relate to a method further including comparing positions of the plurality of identified features to a plane. A subset of the plurality of identified features are discarded based upon the comparison.

In some aspects, the techniques described herein relate to a method further wherein the controller determines the true extrinsic based upon a saved extrinsic, wherein the saved extrinsic relates a saved position and orientation of the camera in six degrees of freedom to the vehicle.

In some aspects, the techniques described herein relate to a method wherein the saved plurality of features are based upon the saved position and orientation of the camera.

In some aspects, the techniques described herein relate to a method wherein the camera is a rear facing arm mounted camera.

In some aspects, the techniques described herein relate to a method wherein the vehicle is a tractor.

In some aspects, the techniques described herein relate to a method wherein the controller determines a projective matrix based upon steps b) and c) and based upon the saved extrinsic.

In some aspects, the techniques described herein relate to a method wherein the controller generates an overlay based upon the projective matrix and displays the overlay and the image from the camera on a display.

In some aspects, the techniques described herein relate to a camera monitoring system (CMS) for a vehicle, the CMS including: a camera; a controller including at least one processor and at least one memory, the at least one memory stores instructions which when executed by the at least one processor cause the CMS to determine a position and an orientation of the camera relative to a vehicle on which the camera is mounted by: a) receiving an image from the camera, the image including a portion of the vehicle on which the camera is mounted; b) detecting a plurality of features on the portion of the vehicle in the image; c) matching the plurality of features identified in step b) to a saved plurality of features; and d) determining an extrinsic based upon step c), wherein the extrinsic relates a position and orientation of the camera in six degrees of freedom relative to the vehicle.

In some aspects, the techniques described herein relate to a camera monitoring system wherein the camera is mounted to the vehicle via an arm and wherein the camera faces rearwardly of the vehicle.

In some aspects, the techniques described herein relate to a camera monitoring system wherein the instructions would further cause the CMS to: e) compare positions of the plurality of features identified in step b) to a plane; and f) discard a subset of the plurality of features identified in step b) based upon step e).

In some aspects, the techniques described herein relate to a camera monitoring system wherein the controller performs step d) based upon a saved extrinsic, wherein the saved extrinsic relates a saved position and orientation of the camera in six degrees of freedom to the vehicle.

In some aspects, the techniques described herein relate to a camera monitoring system wherein the saved plurality of features are based upon the saved position and orientation of the camera.

In some aspects, the techniques described herein relate to a camera monitoring system wherein the controller performs step d) based upon a saved extrinsic.

In some aspects, the techniques described herein relate to a camera monitoring system wherein the controller determines a projective matrix based upon steps b) and c) and based upon the saved extrinsic.

In some aspects, the techniques described herein relate to a camera monitoring system wherein the camera is a rear facing arm mounted camera.

In some aspects, the techniques described herein relate to a camera monitoring system wherein the vehicle is a tractor.

### BRIEF DESCRIPTION OF THE DRAWINGS

The disclosure can be further understood by reference to the following detailed description when considered in connection with the accompanying drawings wherein:

FIG. 1A is a schematic front view of a commercial truck with a camera monitoring system (CMS) used to provide at least Class II and Class IV views.

FIG. 1B is a schematic top elevational view of a commercial truck with a camera monitoring system providing Class II, Class IV, Class V and Class VI views.

FIG. 2 is a schematic top perspective view of a vehicle cabin including displays and interior cameras.

FIG. 3 shows one of the cameras of FIGS. 1A-1B relative to a transformation matrix.

FIG. 4 illustrates an exemplary raw image of a vehicle received from the camera relative to a designed location of the vehicle.

FIG. 5 shows a schematic of a method for operating a CMS.

FIG. 6 shows a display in which an example overlay is projected onto a camera view.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

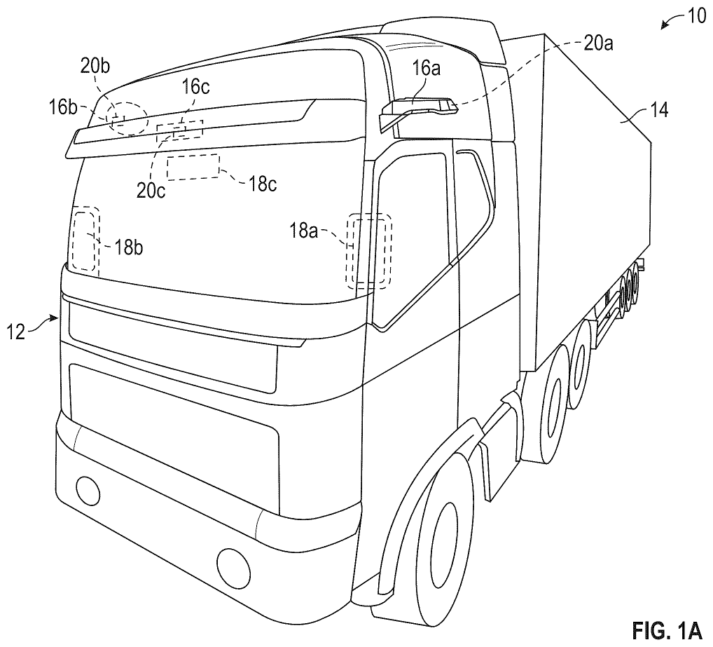

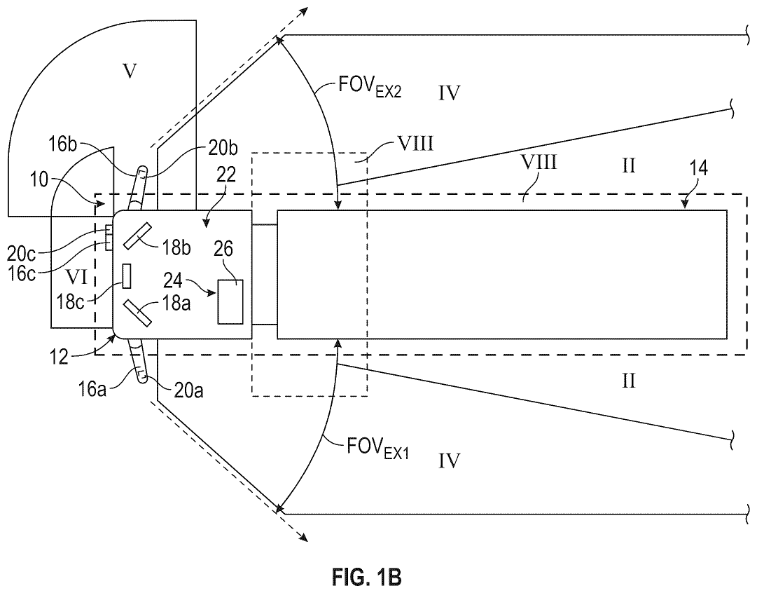

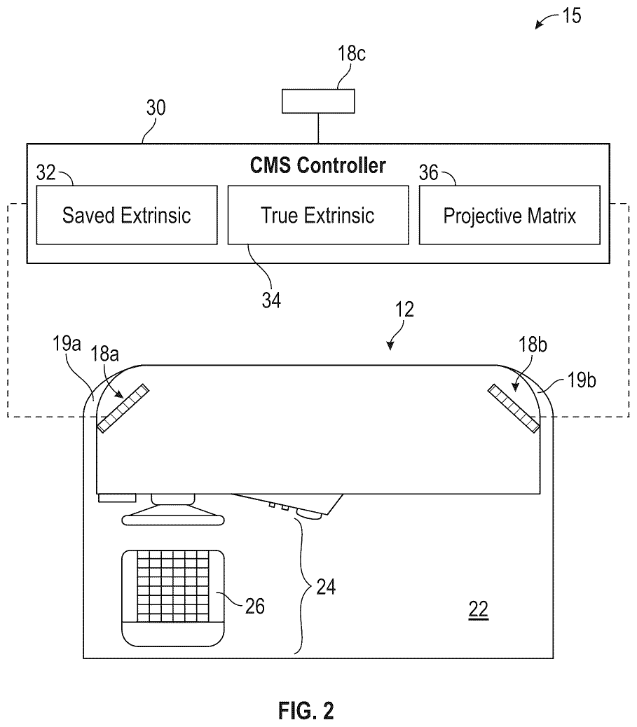

A schematic view of a commercial truck and trailer 10 is illustrated in FIGS. 1A and 1B. The commercial truck and trailer 10 includes a tractor 12 pulling a trailer 14. It should be understood that the tractor 12 and/or trailer 14 may be any configuration and each of the tractor 12 and trailer 14 may be considered a “vehicle” as used herein. Although a commercial truck and trailer is contemplated in this disclosure, the invention may also be applied to other types of vehicles. The commercial truck and trailer 10 incorporates a camera monitoring system (CMS) 15 (FIG. 2) that has driver and passenger side camera arms 16a, 16b mounted to the outside of the tractor 12. If desired, the camera arms 16a, 16b may include conventional mirrors integrated with them as well, although the CMS 15 can be used to entirely replace mirrors. In additional examples, each side can include multiple camera arms, each arm housing one or more cameras and/or mirrors.

Each of the camera arms 16a, 16b includes a base that is secured to, for example, the tractor 12. A pivoting arm is supported by the base and may articulate relative thereto. At least one rearward facing camera 20a, 20b is arranged respectively within camera arms. The exterior cameras 20a, 20b respectively provide an exterior field of view FOV_{EX1}, FOV_{EX2} that each include at least one of the Class II and Class IV views (FIG. 1B), which are legal prescribed views in the commercial trucking industry. The Class II view on a given side of the commercial truck and trailer 10 is a subset of the class IV view of the same side of the commercial truck and trailer 10. Multiple cameras also may be used in each camera arm 16a, 16b to provide these views, if desired. Class II and Class IV views are defined in European R46 legislation, for example, and the United States and other countries have similar drive visibility requirements for commercial trucks. Any reference to a “Class” view is not intended to be limiting, but is intended as exemplary for the type of view provided to a display by a particular camera. Each arm 16a, 16b may also provide a housing that encloses electronics, e.g., a controller 30, that are configured to provide various features of the CMS 15.

First and second video displays 18a, 18b are arranged on each of the driver and passenger sides within the tractor 12 on or near the A-pillars 19a, 19b to display Class II and Class IV views on its respective side of the commercial truck and trailer 10, which provide rear facing side views along the commercial truck and trailer 10 that are captured by the exterior cameras 20a, 20b. In some examples, the first and second video displays 18a, 18b operate as mirror replacement displays, while in other examples they can be operated as supplemental displays to physical mirrors.

If video of Class V and Class VI views are also desired, a camera housing 16c and camera 20c may be arranged at or near the front of the commercial truck and trailer 10 to provide those views (FIG. 1B). A third display 18c arranged within the tractor 12 near the top center of the windshield can be used to display the Class V and Class VI views, which are toward the front of the commercial truck and trailer 10, to the driver.

If additional video views are desired, camera housings can be positioned at the sides and rear of the commercial truck and trailer 10 to provide fields of view including some or all of these zones of the commercial truck and trailer 10. In such examples, the third display 18c can include one or more frames displaying these views. Alternatively, additional displays can be added near the first, second and third displays 18a, 18b, 18c and provide a display dedicated to providing one or more of these views. The displays 18a, 18b, 18c face a driver region 24 within the cabin 22 where an operator is seated on a driver seat 26. The location, size and field(s) of view streamed to any particular display may vary from the configurations described in this disclosure and still incorporate the disclosed invention.

The controller 30 is in communication with the cameras 20 and the displays 18. The controller 30 is configured to implement the various functionality disclosed in this application. The controller 30 may include one or more discrete units.

In terms of hardware architecture, the controller 30 includes at least one processor, at least one memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The controller 30 includes at least one processor for executing software, particularly software stored in the at least one memory, which when executed by the at least one processor performs the functions described herein. The controller 30 can be a custom made or commercially available processor, a central processing unit (CPU), an auxiliary processor among several processors associated with the controller, a semiconductor-based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. The memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The disclosed input and output devices that may be coupled to system I/O interface(s) may include input devices, for example but not limited to, a keyboard, mouse, scanner, microphone, camera, mobile device, proximity device, etc. Further, the output devices, for example but not limited to, a printer, display, etc. Finally, the input and output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the controller 30 is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed. Execution of the instructions in the programs in the memory causes the controller to perform the functions described herein.

Referring to FIG. 2, for each camera, the controller 30 stores a saved extrinsic 32, a true extrinsic 34, and projective matrix 36.

The saved extrinsic 32 is an ideal or designed extrinsic of the camera relative to the tractor 12 specifying all six degrees of freedom. The saved extrinsic 32 specifies the position and orientation of the camera 20 (i.e. camera 20a or camera 20b) relative to the tractor 12, e.g. three-dimensional coordinates (x, y, z) and Euler angles. Other coordinate systems could be used.

The true extrinsic 34 is the actual extrinsic of the camera relative to the tractor 12 specifying all six degrees of freedom. The true extrinsic 34 specifies the actual position and orientation of the camera 20 relative to the tractor 12, e.g. three-dimensional coordinates (x, y, z) and Euler angles. Other coordinate systems could be used. As explained herein, the true extrinsic 34 will often be different from the saved extrinsic 32 because the camera 20 will not be installed in exactly the designed position and orientation, or because the camera 20 will be subsequently moved or rotated, such as by mechanical impact, or because of wear and tear, or because of some combination of these factors.

The projective matrix 36 maps objects viewed by the camera 20 between a three-dimensional space and a two-dimensional plane.

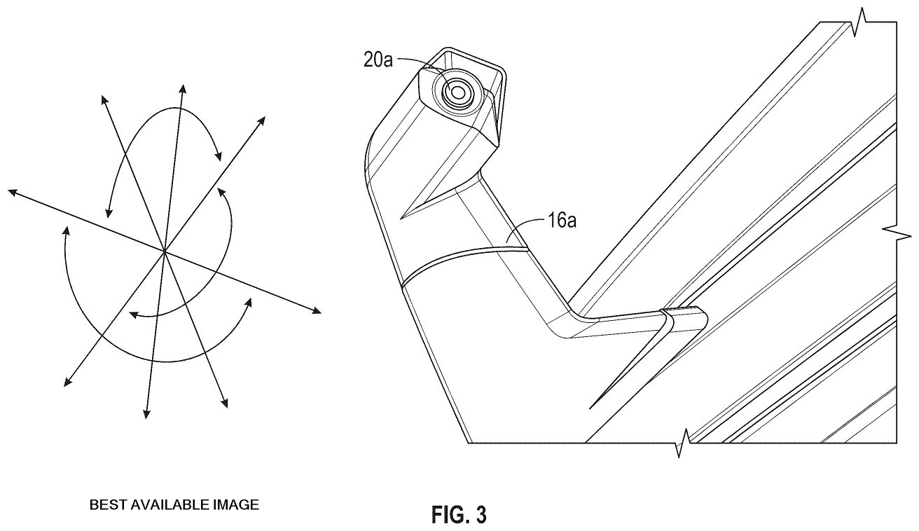

FIG. 3 shows the exterior camera 20a on camera arm 16a; however, it should be recognized that the calibration techniques disclosed herein could be used for any of the cameras 20. For cameras mounted to the tractor 12, the position and orientation would be calibrated relative to the tractor 12. For cameras mounted to the trailer 14, the position and orientation would be calibrated relative to the trailer 14.

As shown in FIG. 3, the exterior camera 20a will have a position and orientation relative to the tractor 12 that can be described in six degrees of freedom. As is well-known, the six degrees of freedom may include a position in three orthogonal axes (e.g. x, y, and z) and a rotation about each of the three orthogonal axes (e.g. roll, pitch, and yaw). Other coordinate systems that fully describe the relative position and orientation could also be used.

As mentioned above, there is an ideal camera position and orientation relative to the tractor 12. The saved extrinsic 32 may set forth a hypothetical or a designed or an ideal camera position and orientation relative to the tractor 12 and relative to points and contours on the tractor 12. Alternatively, the saved extrinsic may be a previously saved and previously updated extrinsic. The techniques described herein create the true extrinsic 34, which describes in six degrees of freedom the relative position and orientation of the camera 20 relative to the tractor 12. The techniques described herein also determine the projective matrix 36.

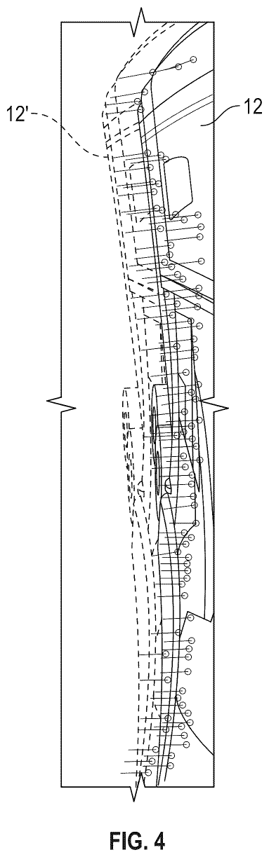

FIG. 4 shows an example image from the camera 20a. The image shows a portion of the exterior of the tractor 12. In broken lines, FIG. 4 shows the relative position of the portion of the exterior of the tractor 12′ in the ideal image, as if taken from a camera at the ideal position. More than one hundred, and more preferably more than five hundred points on the exterior of the tractor 12 are located in the images (a significantly reduced number of representative points is shown for clarity). These points on the exterior of the tractor 12, e.g. edges, corners, joints, openings, etc on the body of the tractor 12 are fixed relative to one another and relative to the rest of the tractor 12 and do not change over time. The positions of these points on the exterior of the tractor 12 are located in the actual image and linked to the corresponding points in the ideal image. These points in the actual image and in the ideal image are used to determine deltas between the saved extrinsic 32 and the true extrinsic 34. in six degrees of freedom.

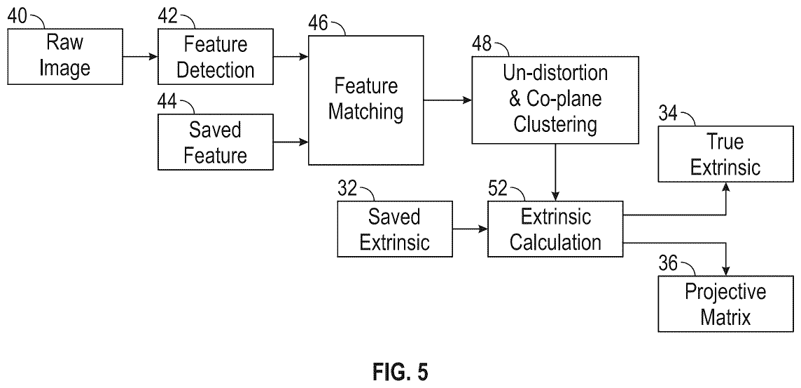

FIG. 5 schematically illustrates a method for determining the true extrinsic 34 and the projective matrix 36. The calibration could be performed periodically (e.g. at every startup of the CMS) or upon request by the user (via a user interface).

A raw image 40 is received from the camera 20 (such as camera 20a or camera 20b). A feature detection module 42 in the controller 30 analyzes the raw image 40 from the camera 20 to find the points, edges, contours and/or other features of FIG. 4. The feature detection module 42 may use ORB (Oriented Fast and Rotated Brief) or SURF method (Speeded Up Robust Features) or other known image analysis techniques.

Saved features 44 are a template or 3D model of the tractor 12 shape, including the points, edges, contours and/or other features of FIG. 4. A feature matching module 46 compares and matches the points, edges, contours and/or other features detected by the feature detection module 42 based upon the actual, raw image 40 from camera 20 to the saved features 44.

In an un-distortion and co-plane clustering module 48, undistortion is performed on the matched features, such as the correction of lens distortion. Additionally, in un-distortion and co-plane clustering module 48, the features (points, edges, contours and/or other features) that are within a certain threshold of a plane are clustered. Such features that are outside the threshold of the plane are discarded. The side of the tractor 12 is substantially planar. A large majority of detected features should be within a threshold of a plane. Features that are detected significantly outside that plane are not part of the tractor 12 but may be features from the ground or other objects in the background of the raw image 40. Those features outside the plane are discarded in the un-distortion and co-plane clustering module 48.

An extrinsic calculation module 52 receives the matched features and estimates the delta/changes in real time between the saved features 44 and the detected features in the raw image 40. The extrinsic calculation module 52 estimates the delta/changes in the extrinsic in real time and using the saved extrinsic.

Based upon the deltas or changes between the saved features 44 and the detected features in the raw image 40 and based upon the saved extrinsic 32, the extrinsic calculation module 52 calculates the true extrinsic 34 and the projective matrix 36.

The projective matrix 36 can then be used in any of several ways. The actual position of an object in the two-dimensional image can be determined in three dimensions correctly relative to the tractor 12. Overlays onto the object in the image as displayed on one of the displays 18 will be more accurately aligned with the actual positions of the objects in the image, including the tractor 12 and the trailer 14. Locations of objects relative to the tractor 12 will also be more accurately determined based upon the projective matrix 36.

Alternatively, or additionally, the extrinsic calculation module 52 can compare the current camera position and orientation to the saved extrinsic 32 at startup or periodically and warn the driver if the deltas exceed a predetermined threshold. The CMS can then give the driver the option of performing a full recalibration of the camera position and orientation. The extrinsic calculation module 52 can wait to calculate the true extrinsic 34 and the projective matrix 36 until receiving confirmation from the driver.

A more specific example technique will be described below. The matched feature points (FIG. 4) from the two images taken from camera location A and B are denoted as as X_{A} and X_{B}. The feature points were matched in feature matching module 46 and as explained above, some feature points were discarded in the un-distortion and co-plane clustering module 48. Camera location A is the ideal camera location and camera location B is the actual camera location

Then the fundamental matrix F relates the matched points in the two images through the following:

$${X}_{B}^{T} F {X}_{A} = 0$$

F can be estimated using methods like the eight-point algorithm, which is well-known in computer vision research area.

Suppose we know the camera intrinsic as

$$K = ( \begin{matrix}{f}_{x} & 0 & {c}_{x} \\ 0 & {f}_{y} & {c}_{y} \\ 0 & 0 & 1\end{matrix} )$$

The essential matrix can be estimated as

Eₛₛ=K^{T}FK

Then we can perform singular value decomposition with Eₛₛ

Eₛₛ=UΣV^{T}

To get U and V, where U is an m×m complex unitary matrix with non-negative numbers on the diagonal and V is an n×n complex unitary matrix.

The translation vector is the last column of the U matrix

t=U(:,3)

The rotation matrix R has two candidates

R₁=UWV^{T}

R₂=UW^{T}V^{T}

Where

$$W = [ \begin{matrix}0 & - 1 & 0 \\ 0 & 0 & 0 \\ 0 & 0 & 1\end{matrix} ]$$

And the correct rotation matrix is selected through triangulation depth method.

In the end, the extrinsic from A to B is determined as

$${E}_{A - B} = [ \begin{matrix}{R}_{3 \times 3} & {t}_{3 \times 1} \\ {0}_{1 \times 3} & 1\end{matrix} ]$$

And the extrinsic at position B with respect to vehicle ISO is

E_{B}=E_{A}E_{A-B}

Where E_{B} is the true extrinsic 34 and E_{A} is the saved extrinsic 32.

The projective matrix 36 (P) is the product of the camera intrinsic K and

the true extrinsic 34.

P=[K]₃ₓ₄[E]₄ₓ₄

As is known, the projective matrix 36 projects points from the real world 3-dimensional space onto a 2-dimensional plane, such as one of the displays 18a, 18b, 18c. One example way of determining the projection is shown below, where x, y, z are the three-dimensional coordinates of the point in the real world and (u*,v*) are pixels without normalization.

$${[ \begin{matrix}{u}^{*} \\ {v}^{*} \\ w\end{matrix} ]}_{3 \times 1} = {{{[ K ]}_{3 \times 4} [ E ]}_{4 \times 4} [ \begin{matrix}x \\ y \\ z \\ 1\end{matrix} ]}_{4 \times 1}$$

In the final two-dimensional image, the pixel location (u, v) would be:

$$u = \frac{{u}^{*}}{w}$$

$$v = \frac{{v}^{*}}{w}$$

There are many known potential uses for the projective matrix. For example, the projective matrix 36 is used to project (i.e. overlay) a warning distance line onto the current view from one of the cameras one of the displays 18a, 18b, 18c.

The projective matrix 36 can also be used to predict vehicle trajectory onto one of the displays 18a, 18b, 18c, such as by overlaying one or more lines showing the predicted vehicle trajectory onto the current view from the camera, so the driver can have a better visualization.

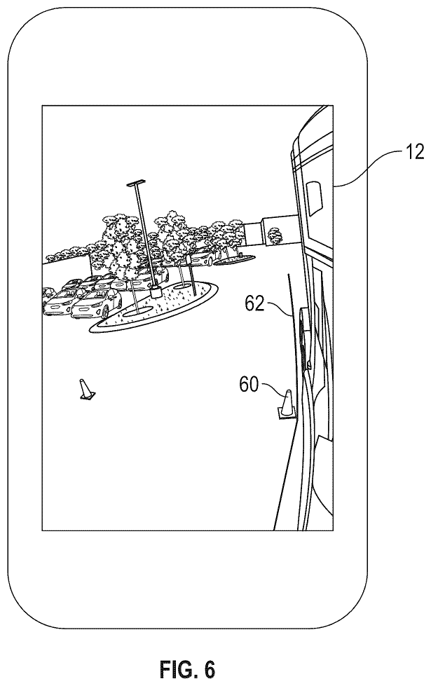

As shown in FIG. 6, a warning line 62 can be overlayed onto the camera view relative to an object 60 on the display.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers for operations or method steps are for ease of reference in dependent claims and do not indicate a required sequence unless explicitly stated in the claims.

1. A method for calibrating a camera position on a vehicle including:
a) receiving an image from a camera at a controller, the image including a portion of a vehicle to which the camera is mounted;
b) the controller identifying a plurality of features on the portion of the vehicle in the image;
c) the controller matching the plurality of features identified in step b) to a saved plurality of features; and
d) the controller determining a true extrinsic based upon step c), wherein the true extrinsic relates a position and orientation of the camera in six degrees of freedom to the vehicle.

2. The method of claim 1, wherein the camera is a rear facing arm mounted camera.

3. The method of claim 1 further including:
e) comparing positions of the plurality of features identified in step b) to a plane; and
f) discarding a subset of the plurality of features identified in step b) based upon step e).

4. The method of claim 1 further wherein the controller performs step d) based upon a saved extrinsic, wherein the saved extrinsic relates a saved position and orientation of the camera in six degrees of freedom to the vehicle.

5. The method of claim 4 wherein the saved plurality of features are based upon the saved position and orientation of the camera.

6. The method of claim 5 wherein the camera is a rear facing arm mounted camera.

7. The method of claim 6 wherein the vehicle is a tractor.

8. The method of claim 7 wherein the controller determines a projective matrix based upon steps b) and c) and based upon the saved extrinsic.

9. The method of claim 8 wherein the controller generates an overlay based upon the projective matrix and displays the overlay and the image from the camera on a display.

10. A camera monitoring system (CMS) for a vehicle, the CMS comprising:
a camera;
a controller including at least one processor and at least one memory, the at least one memory stores instructions which when executed by the at least one processor cause the CMS to determine a position and an orientation of the camera relative to a vehicle on which the camera is mounted by:
a) receiving an image from the camera, the image including a portion of the vehicle on which the camera is mounted;
b) identifying a plurality of features on the portion of the vehicle in the image;
c) matching the plurality of features identified in step b) to a saved plurality of features; and
d) determining an extrinsic based upon step c), wherein the extrinsic relates a position and orientation of the camera in six degrees of freedom relative to the vehicle.

11. The camera monitoring system of claim 10 wherein the camera is mounted to the vehicle via an arm and wherein the camera faces rearwardly of the vehicle.

12. The camera monitoring system of claim 10 wherein the instructions would further cause the CMS to:
e) compare positions of the plurality of features identified in step b) to a plane; and
f) discard a subset of the plurality of features identified in step b) based upon step e).

13. The camera monitoring system of claim 10 wherein the controller performs step d) based upon a saved extrinsic, wherein the saved extrinsic relates a saved position and orientation of the camera in six degrees of freedom to the vehicle.

14. The camera monitoring system of claim 13 wherein the saved plurality of features are based upon the saved position and orientation of the camera.

15. The camera monitoring system of claim 10 wherein the controller performs step d) based upon a saved extrinsic.

16. The camera monitoring system of claim 15 wherein the controller determines a projective matrix based upon steps b) and c) and based upon the saved extrinsic.

17. The camera monitoring system of claim 10 wherein the camera is a rear facing arm mounted camera.

18. The camera monitoring system of claim 10 wherein the vehicle is a tractor.

19. The method of claim 1, wherein the saved plurality of features comprises a three-dimensional model of the portion of the vehicle.

20. The method of claim 19, wherein the plurality of features comprises more than one hundred features on the portion of the vehicle.

21. A camera monitoring system (CMS) for a tractor, the CMS comprising:
a camera;
a controller including at least one processor and at least one memory, the at least one memory storing instructions which when executed by the at least one processor cause the CMS to determine a position and an orientation of the camera relative to a tractor on which the camera is mounted by:
a) receiving an image from the camera, the image including a portion of the tractor on which the camera is mounted;
b) identifying a plurality of features on the portion of the tractor in the image;
c) matching the plurality of features identified in step b) to a saved plurality of features, wherein the saved plurality of features comprises a three-dimensional model of the portion of the tractor, and wherein the plurality of features comprises more than one hundred features on the portion of the tractor; and
d) determining an extrinsic based upon step c) and based upon a saved extrinsic, wherein the extrinsic relates a position and orientation of the camera in six degrees of freedom relative to the tractor, and wherein the saved extrinsic relates a saved position and orientation of the camera in six degrees of freedom to the tractor;
wherein the controller determines a projective matrix based upon steps b) and c) and based upon the saved extrinsic.

22. The camera monitoring system of claim 21, wherein the plurality of features comprises more than five hundred features on the portion of the tractor.
